(19) United States
(12) Patent Application Publication
(10) Pub. No.: US 2026/0289865 A1
(43) Pub. Date: Sep. 24, 2026

(54) SYSTEMS AND METHODS FOR REAL-TIME AI-DRIVEN IMAGE ANALYSIS WITH MULTI-MODEL ARCHITECTURE

(71) Applicant: 40 North Labs, LLC, Park City, UT (US)

(72) Inventors: Michael Benjamin Crosby, Murray, UT (US); Richard Michael McEwen, Murray, UT (US)

(73) Assignee: 40 North Labs, LLC, Park City, UT (US)

(21) Appl. No.: 19/576,986

(22) Filed: Mar. 24, 2026

Related U.S. Application Data
(60) Provisional application No. 63/776,582, filed on Mar. 24, 2025.

(51) Int. Cl. G06T 11/60; G06F 21/62; G06T 1/60; G06V 10/764

(52) U.S. Cl. CPC G06T 11/60; G06F 21/6254; G06T 1/60; G06V 10/764

(57) ABSTRACT

A computer-implemented method for real-time AI-driven image analysis with multi-model architecture may include receiving image data having a corresponding processing configuration and identifying a processing status for the received image data, the processing status indicating prior image analysis on the image data. The method may also include determining, from the processing status and the processing configuration, one or more image analysis operations to be performed to create metadata for the image data. The method may further include coordinating one or more artificial intelligence (AI) models to perform the one or more image analysis operations and create the metadata and outputting the metadata for the image data. Various other methods, systems, and computer-readable media are also disclosed.

### CROSS REFERENCE TO RELATED APPLICATION

This application claims the benefit of U.S. Provisional Application No. 63/776,582, filed Mar. 24, 2025, the disclosure of which is incorporated herein, in its entirety, by this reference.

### BACKGROUND

In many image-management environments, large numbers of digital images can be captured, uploaded, transferred, organized, and reviewed over relatively short periods of time. For example, images associated with sporting events, live events, corporate events, school activities, media workflows, or security-related environments can be expected to become searchable and usable shortly after capture. Existing image-management tools can provide mechanisms for storing, browsing, and distributing images, but can rely heavily on manual review, manual tagging, or delayed post-processing to identify content represented in the images. As image volumes increase, such approaches can become difficult to scale and can delay downstream use of the images. In addition, in some workflows, image-processing criteria may be adjusted over time (e.g., on an event-by-event or project-by-project basis), which can cause repeated reprocessing of the same image files and further increase computational expense and latency.

Some image-analysis approaches employ artificial intelligence models to detect limited categories of content in images, such as faces, text, objects, or other visual features. In cases where multiple different types of analysis are desired for the same image set, existing systems can require separate processing passes, separate tools, or repeated execution of computationally expensive models. Such repeated processing can consume substantial processor, memory, and graphics-processing resources, particularly in workflows in which image-analysis criteria are adjusted over time or in which some categories of detections are relevant for a particular event or project. For example, conventional approaches may rerun model inference on previously analyzed images when configuration settings change, rather than selectively reusing previously generated intermediate results and selectively reapplying downstream filtering or output logic. In addition, existing tagging workflows can fail to preserve generated tags in embedded image metadata, which can reduce portability and limit later search and retrieval across different platforms.

Accordingly, there is a desire for improved systems and methods for image analysis and image management that can process image data more efficiently, selectively apply different categories of image analysis, reduce redundant execution of image-analysis operations, and generate metadata that can be used for search, classification, modification, access control, and related image-handling operations.

The present disclosure, therefore, identifies and addresses a need for systems and methods for real-time ai-driven image analysis with multi-model architecture.

### SUMMARY

As will be described in greater detail below, the present disclosure describes various systems and methods for real-time ai-driven image analysis with multi-model architecture.

In one example, a method for real-time ai-driven image analysis with multi-model architecture may include (i) receiving image data having a corresponding processing configuration, (ii) identifying a processing status for the received image data, the processing status indicating prior image analysis on the image data, (iii) determining, from the processing status and the processing configuration, one or more image analysis operations to be performed to create metadata for the image data, (iv) coordinating one or more artificial intelligence (AI) models to perform the one or more image analysis operations and create the metadata, and (v) outputting the metadata for the image data.

In some examples, the method further includes updating the processing status after completing an image analysis operation to indicate completion of the image analysis operation and storage of a corresponding analysis result. In some examples, the metadata comprises at least one of: object metadata identifying an object represented in the image data, facial metadata identifying a person represented in the image data, alphanumeric metadata extracted from text represented in the image data, color metadata identifying at least one color represented in the image data, graphic metadata identifying a graphic represented in the image data, logo metadata identifying a logo represented in the image data, or credential metadata identifying credential information represented in the image data. In some examples, the metadata further comprises AI-generated caption metadata describing at least a portion of a depicted scene. In some examples, logo metadata is generated using one or more client-provided logos received via an administrative interface, and the one or more client-provided logos are used as reference data during logo recognition. In some examples, the processing status comprises, for each of a plurality of image analysis operation types, an indication of whether the corresponding image analysis operation has been completed for the image data and whether a stored prior analysis result is available for reuse. In some examples, the stored prior analysis result comprises intermediate data, including facial embeddings, that can be reused to compare newly enrolled faces against previously processed images without rerunning facial inference on those previously processed images.

In some examples, the method further includes modifying the image data based on the metadata and the processing configuration. In some examples, modifying the image data further comprises at least one of: obscuring sensitive information in the image data, embedding the metadata into the image data, or updating embedded metadata in the image data.

In some examples, the method further includes validating at least a portion of the metadata. In some examples, validating the at least a portion of the metadata comprises applying a validator model and/or applying rule-based validation logic and/or receiving user review input to detect a discrepancy in an output of the one or more AI models and providing corrective feedback based on the discrepancy. In some examples, the method further includes receiving a validation input via a user interface to modify the metadata and using the validation input as training feedback to refine subsequent creation of the metadata. In some examples, the method further includes validating at least a portion of the metadata. In some examples, validating the at least a portion of the metadata comprises applying rule-based validation logic, user review, a machine-learning validator, or a combination thereof to detect a discrepancy in an output of one or more image analysis operations and, in response, updating metadata associated with the image data and/or providing corrective feedback.

In one embodiment, a system for real-time ai-driven image analysis with multi-model architecture may include one or more processing nodes configured to host at least one artificial intelligence (AI) model trained for image analysis, and at least one physical processor and physical memory that includes computer-executable instructions that, when executed by the physical processor, cause the physical processor to (i) receive image data having a corresponding processing configuration, (ii) identify a processing status associated with the image data, the processing status indicating prior image analysis on the image data, (iii) determine, from the processing status and the processing configuration, one or more image analysis operations to be performed to create metadata for the image data, (iv) coordinate the one or more processing nodes to perform the one or more image analysis operations using the at least one AI model to create the metadata, and (v) output the metadata. In some examples, the one or more processing nodes execute an identical scanner program, and non-overlapping image analysis operations are distributed across the one or more processing nodes by configuration settings that specify, for each processing node, which image analysis operation types are deactivated on that processing node.

In some examples, coordinating the one or more processing nodes comprises selecting a processing node that hosts an AI model corresponding to the one or more image analysis operations to execute the AI model. In some examples, coordinating the one or more processing nodes comprises distributing non-overlapping image analysis operations to different processing nodes based on analysis type. In some examples, coordinating the one or more processing nodes comprises using, for the one or more image analysis operations, a stored prior analysis result identified from the processing status. In some examples, coordinating the one or more processing nodes comprises selectively activating an AI model hosted by a processing node based on availability of at least one of processing capacity, memory capacity, or graphics processing capacity of the processing node. In some examples, the system sequentially executes one image analysis operation type at a time to bound GPU memory usage and maintain a predictable processing pipeline. In some examples, coordinating the one or more processing nodes comprises causing a given processing node to skip disabled image analysis operation types before loading image files for those disabled image analysis operation types.

In some examples, each processing node stores a local cache comprising prior analysis results and processing status for AI models hosted by the processing node. In some examples, outputting the metadata comprises writing tags to EXIF metadata of the image data. In some examples, outputting the metadata comprises classifying the image data within a searchable image catalog. In some examples, each processing node stores local cache entries only for image analysis operation types assigned to that processing node, and results written from different processing nodes are additive for the same image data.

In some examples, the metadata comprises at least one of: object metadata, facial metadata, alphanumeric metadata, color metadata, graphic metadata, logo metadata, or credential metadata. In some examples, the computer-executable instructions, when executed by the at least one physical processor, further cause the at least one physical processor to redact a portion of the image data based on the metadata indicating sensitive information. In some examples, the computer-executable instructions, when executed by the at least one physical processor, further cause the at least one physical processor to validate at least a portion of the metadata using a validator model to detect a discrepancy in output of an AI model.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (i) receive image data having a corresponding processing configuration, (ii) identify a processing status for the received image data, the processing status indicating prior image analysis on the image data, (iii) determine, from the processing status and the processing configuration, one or more image analysis operations to be performed to create metadata for the image data, (iv) coordinate one or more artificial intelligence (AI) models to perform the one or more image analysis operations and create the metadata, and (v) output the metadata for the image data.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIGS. 1A-C are a flow diagram of an example process for a real-time ai-driven image analysis with multi-model architecture.

FIG. 2 is a dataflow diagram of an example workload distribution for a real-time ai-driven image analysis with multi-model architecture.

FIG. 3 is a diagram of example timelines of distributed workloads for a real-time ai-driven image analysis with multi-model architecture.

FIG. 4 is a block diagram of an example system for real-time ai-driven image analysis with multi-model architecture.

FIG. 5 is a block diagram of an additional example system for real-time ai-driven image analysis with multi-model architecture.

FIG. 6 is a flow diagram of an example method for real-time ai-driven image analysis with multi-model architecture.

FIG. 7 is a block diagram of an example computing system capable of implementing one or more of the embodiments described and/or illustrated herein.

FIG. 8 is a block diagram of an example computing network capable of implementing one or more of the embodiments described and/or illustrated herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to systems and methods for real-time ai-driven image analysis with multi-model architecture. In some embodiments, the disclosed image-processing architecture improves operation of computerized image-management systems by processing image data according to both a processing configuration corresponding to the image data and a processing status indicating prior image analysis already performed on the image data. In some embodiments, the processing status comprises operation-specific state data maintained for the image data, including per-image and per-image-analysis-operation completion indicators and, when available, stored prior analysis results for reuse. In some embodiments, the processing status further comprises, or is maintained in association with, one or more configuration snapshots or configuration hashes usable to detect whether an event configuration applicable to a given image analysis operation type has changed. In some embodiments, the stored prior analysis results include intermediate data, such as facial embeddings or other feature representations, that can be reused for later comparisons without rerunning the corresponding image analysis model on previously processed image data. Rather than relying on manual tagging workflows or repeatedly applying a large monolithic model to each image, a computing device may determine, from the processing status and the processing configuration, which image analysis operations remain to be performed for the image data, and may then coordinate one or more artificial intelligence models to perform those image analysis operations and generate metadata for the image data. In some embodiments, two layers of efficiency are implemented, including (i) per-file and per-operation processed flags that prevent re-queueing completed work when configuration is unchanged, and (ii) a detection result cache that stores prior analysis results and enables reuse of those prior analysis results to avoid rerunning model inference even when files are requeued after a configuration change. In some embodiments, when a configuration change is detected for an image analysis operation type, the system clears corresponding processed flags to permit re-evaluation under updated criteria, while still using cached prior analysis results such that downstream filtering and output logic can be re-executed without repeated inference.

By using the processing status as a control input to govern whether additional image analysis is needed, the disclosed systems can reduce redundant model execution, conserve processor, memory, and graphics-processing resources, decrease latency for real-time or near-real-time image workflows, and improve throughput for large image collections. The resulting metadata may then be output for search, classification, embedded metadata updates, redaction, or other downstream image-handling functions, thereby providing a technically improved and more efficient image-analysis pipeline as compared with traditional image-management systems that depend on manual organization, repetitive reprocessing, or inflexible single-model analysis. In some embodiments, image analysis is performed sufficiently near a time of capture or upload that tags, favorites, classifications, or other metadata become available across browser-based interfaces, native applications, and kiosk interfaces within minutes of image availability. By front-loading image analysis and metadata generation earlier in the image-management pipeline, the disclosed systems can reduce later reprocessing and improve responsiveness of downstream image-retrieval workflows.

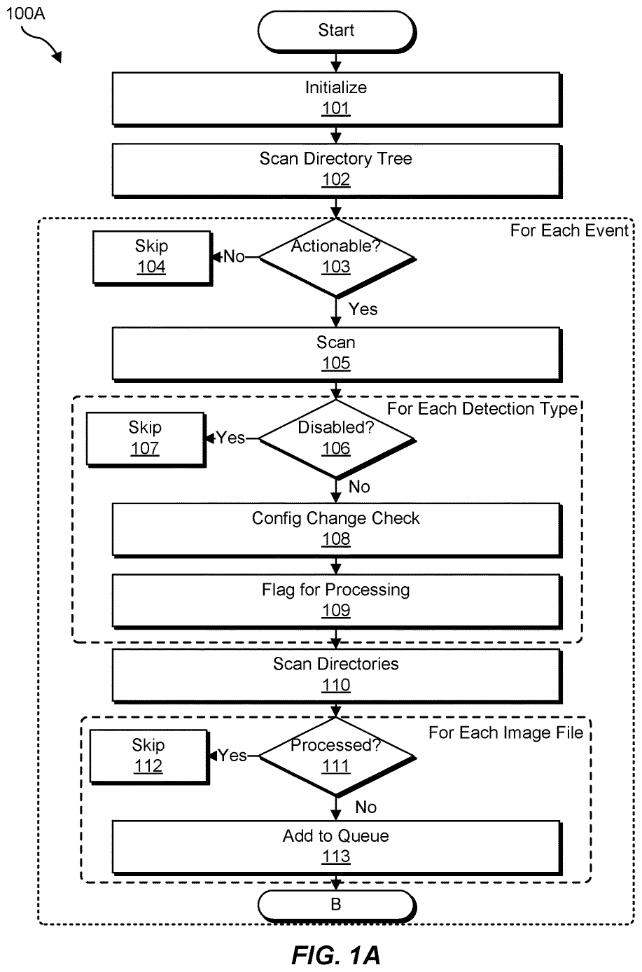

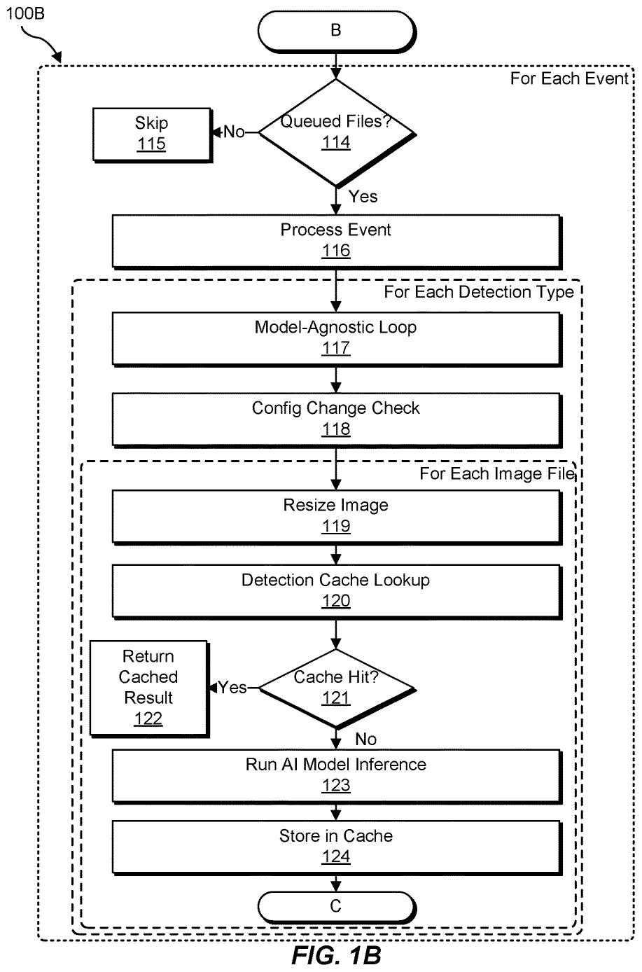

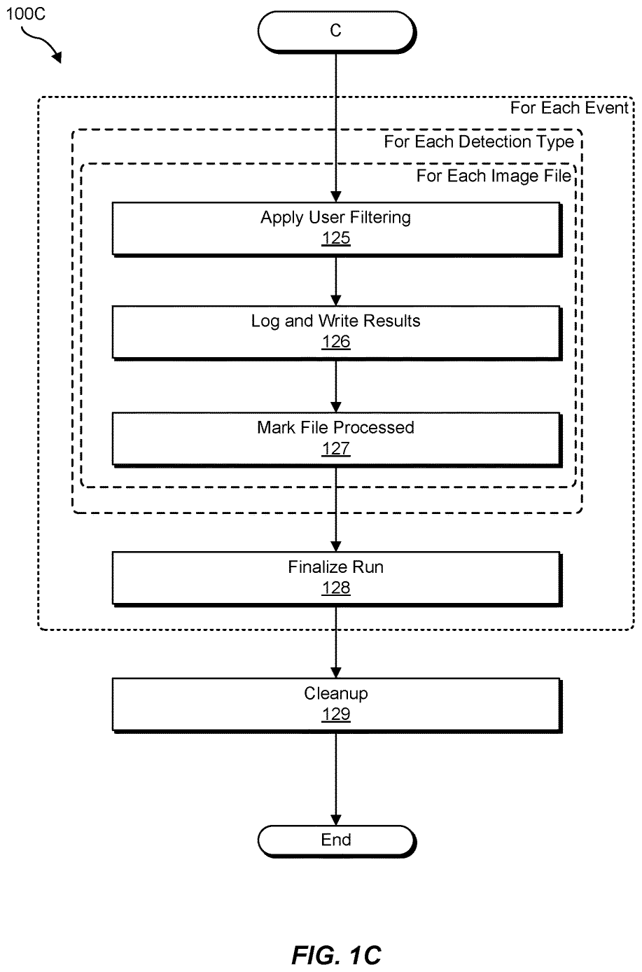

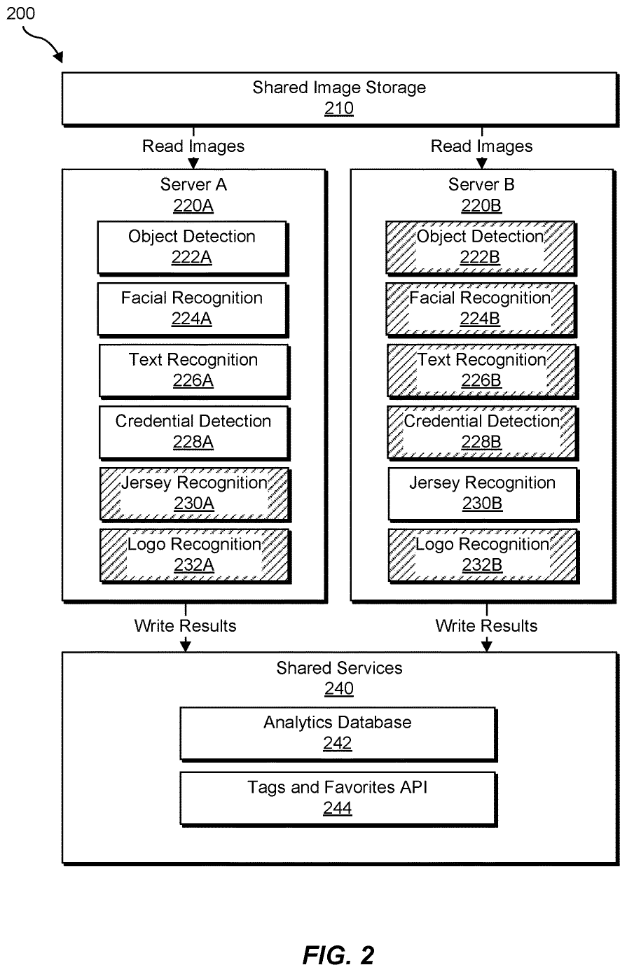

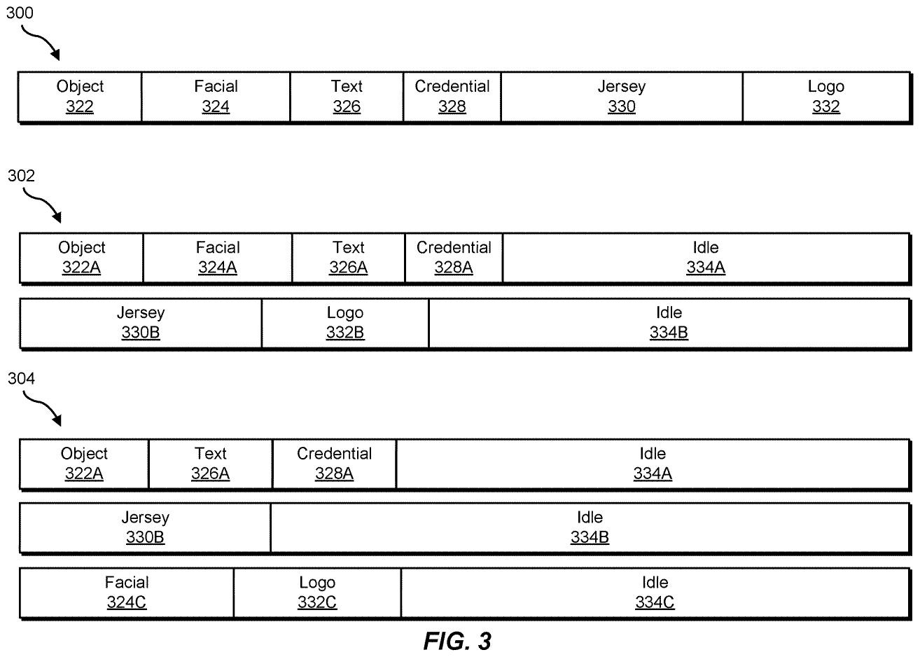

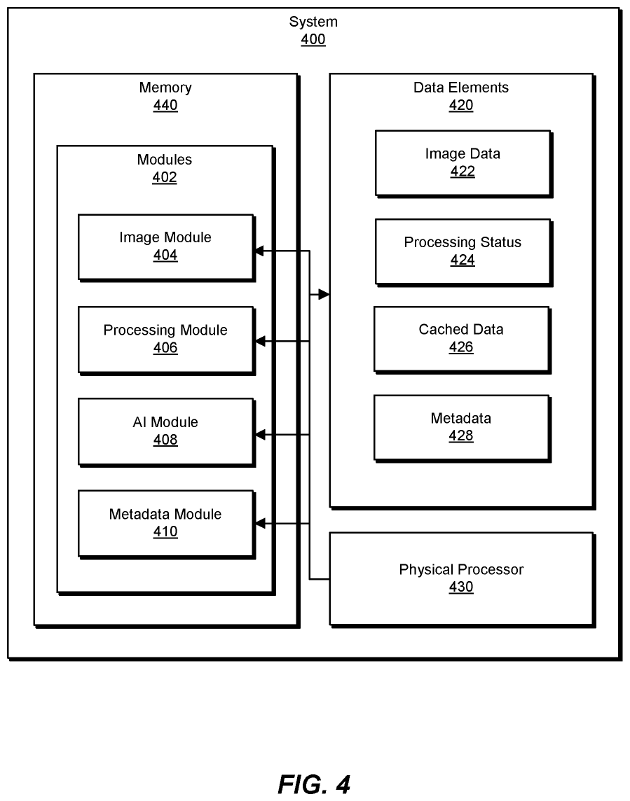

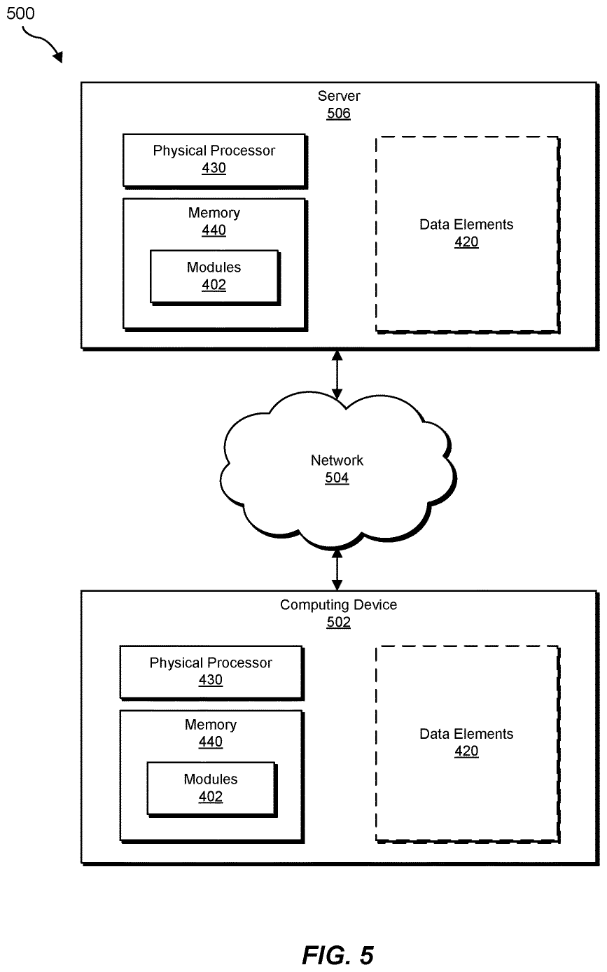

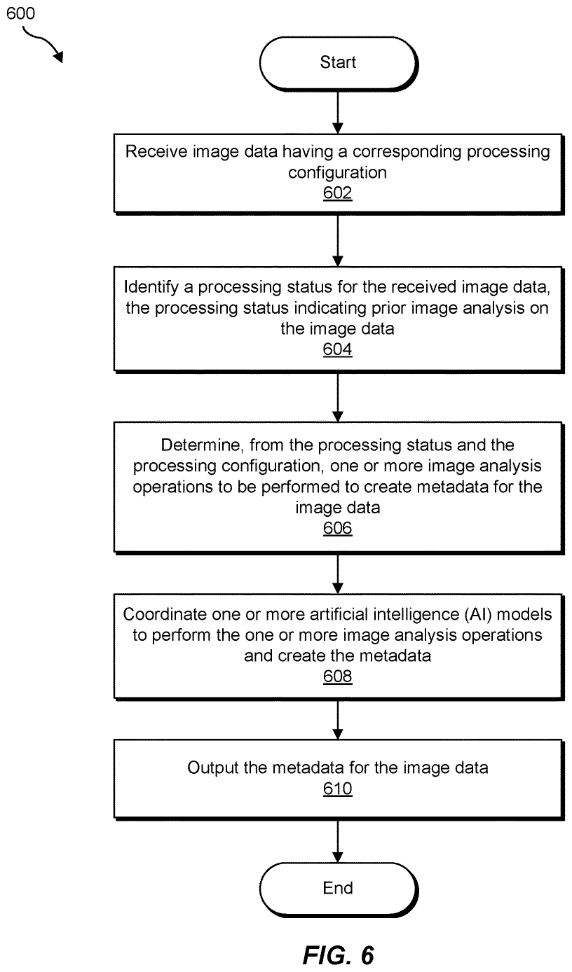

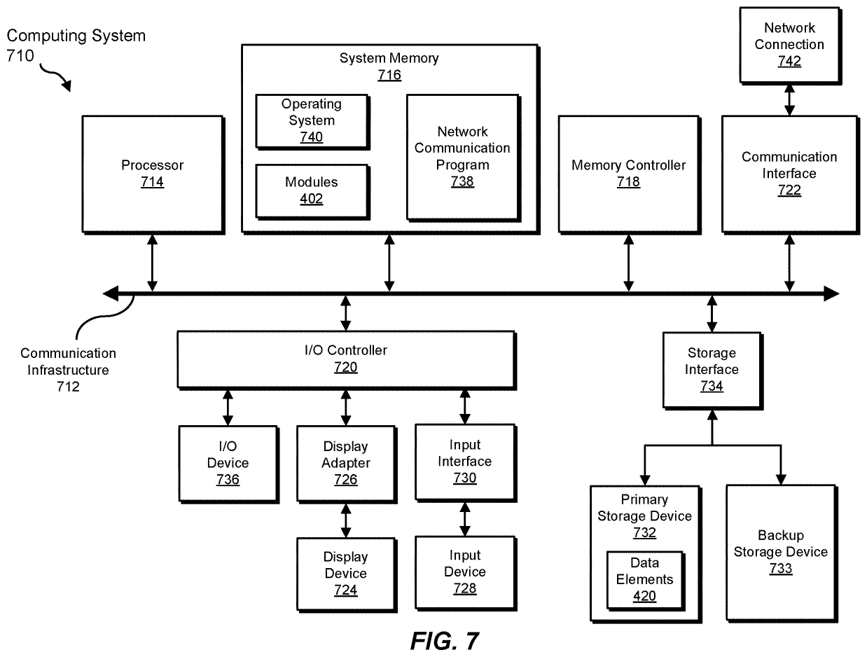

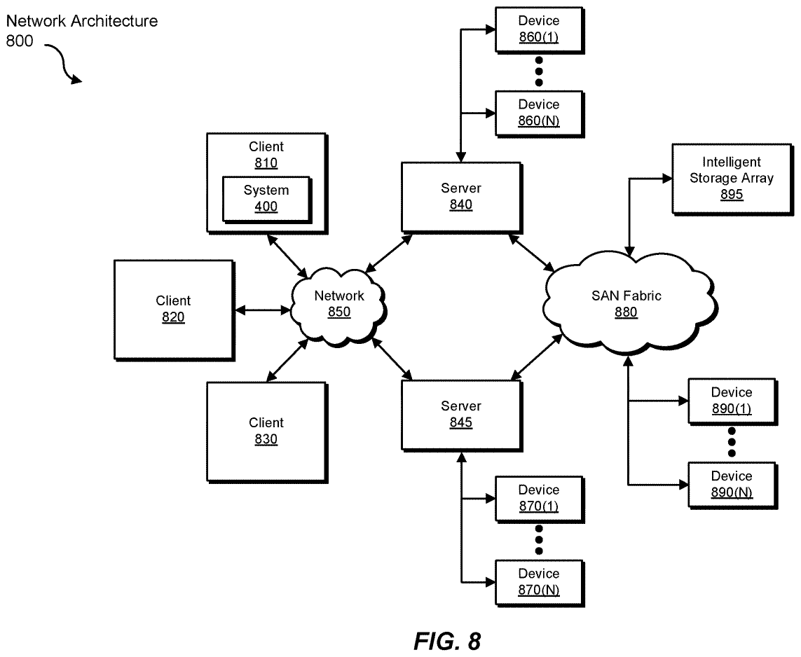

The following will provide, with reference to FIGS. 1A-6, detailed descriptions of example systems for real-time ai-driven image analysis with multi-model architecture. Detailed descriptions of an example scanning process will be provided in connection with FIGS. 1A-1C. Detailed descriptions of distributed AI workloads will be provided in connection with FIGS. 2 and 3. Detailed descriptions of example systems and network architectures for real-time ai-driven image analysis with multi-model architecture will be provided in connection with FIGS. 4 and 5. Detailed descriptions of corresponding computer-implemented methods will also be provided in connection with FIG. 6. In addition, detailed descriptions of an example computing system and network architecture capable of implementing one or more of the embodiments described herein will be provided in connection with FIGS. 7 and 8, respectively.

FIG. 1A shows a flowchart 100A of an example computer-implemented method for efficient scanning of one or more images associated with a specified event using change detection, result caching, and model-agnostic processing. In some embodiments, the flowchart 100A corresponds to an upstream scan workflow that identifies which image files should be evaluated for one or more image analysis tasks, and then provides the selected image files to downstream processing (e.g., via connector B as will be described further below with respect to FIG. 1B) that can include an image accessing module configured to access one or more images, a model identifying module configured to identify which one or more of a plurality of available image analysis models are to be implemented to perform one or more image analysis tasks related to the accessed images, an instantiation module configured to instantiate the one or more identified image analysis models to perform the one or more image analysis tasks related to the accessed images, and an image data generating module configured to generate image metadata associated with the one or more images, wherein each of the identified image analysis models provides different metadata information related to the accessed images.

In some embodiments, the flowchart 100A begins at a start state and proceeds to an initialize 101. In some embodiments, initialize 101 includes loading a global configuration (e.g., scan.ini), connecting to an analytics database (e.g., MySQL), and opening a local cache (e.g., a key-value cache). Initialize 101 may further include preparing file system access to one or more directories that store image galleries, initializing run-time state for scanning, and preparing cache key formats used later for configuration snapshots, per-file processing flags, and detection results.

Flowchart 100A then proceeds to a scan directory tree 102. In some embodiments, scan directory tree 102 walks a scan path that includes one or more client directories and one or more event directories (e.g., a structure such as scan_path/{client}/{event}), thereby discovering one or more specified events and their associated gallery directories. In some embodiments, scan directory tree 102 is performed against shared image storage, such that multiple scanner instances can mount and read from the same directory structure.

For each discovered specified event, flowchart 100A proceeds to an actionable decision 103. In some embodiments, actionable decision 103 determines whether the specified event has a valid configuration with any actionable detections enabled. In some embodiments, actionable decision 103 checks whether an event configuration file (e.g., autotagging.json) exists and contains at least one detection type that is enabled and configured to write outputs such as image tags or favorites (e.g., enabled+(add_tags or add_favorites)). If actionable decision 103 indicates that no actionable detections are enabled, flowchart 100A proceeds to a skip 104 and the specified event is bypassed. This may reduce unnecessary computational work by avoiding file-level scanning and downstream image analysis tasks for events that are not configured to produce outputs.

If actionable decision 103 indicates that the specified event is actionable, flowchart 100A proceeds to a scan 105. In some embodiments, a scan 105 begins an event scan for the specified event and includes loading the event configuration and entering an event-specific scan routine (e.g., scan_event( )). In some embodiments, scan 105 establishes the set of detection types that may be applied to images associated with the specified event, and establishes any event-specific criteria that later determine whether raw detections become actionable outputs such as image tags, favorites, or other image metadata.

Flowchart 100A then proceeds to a disabled decision 106 for a detection type. In some embodiments, disabled decision 106 determines whether that detection type is deactivated (e.g., globally deactivated in scan.ini and/or deactivated for the specified event). If disabled decision 106 indicates the detection type is deactivated, flowchart 100A proceeds to a skip 107 to bypass that detection type before any images are loaded for that detection type. In some embodiments, this supports a distributed processing variation in which multiple scanner instances run concurrently on different servers, each server running the same program but using different configuration settings that indicate which detection types are deactivated on that server. In such embodiments, detection types can be partitioned across servers (non-overlapping), so that no two servers process the same detection type, and each server maintains its own local cache for its assigned detection types while reading images from the same shared image storage and writing results through shared output targets (e.g., an analytics database and one or more endpoints for writing image tags and favorites).

For a detection type that is not deactivated, flowchart 100A proceeds to a config change check 108. In some embodiments, config change check 108 compares a current configuration for the specified event and the detection type against a previously stored version, such as a configuration snapshot or configuration hash stored per-event and per-detection-type in the local cache. In some embodiments, config change check 108 is a lightweight comparison (e.g., a json comparison) and is performed without loading images at this stage.

Flowchart 100A then proceeds to a flag for processing 109 based on config change check 108. In some embodiments, flag for processing 109 indicates whether the configuration is changed (e.g., a configuration changed flag triggering full reprocessing) or the configuration is unchanged (e.g., a configuration unchanged flag triggering processing of new files only). In some embodiments, when the configuration is changed, per-file, per-detection-type processed flags (e.g., local processed flags) for that detection type are cleared, thereby enabling a full rescan for that detection type under updated settings. In some embodiments, when the configuration is unchanged, the processed flags remain in place so that only new or unprocessed files are considered for that detection type.

Flowchart 100A next proceeds to a scan directories 110. In some embodiments, scan directories 110 scans one or more gallery directories associated with the specified event and lists image files across the galleries. In some embodiments, the image files may include one or more of *.jpg, *.jpeg, *.png, and *.gif files. Flowchart 100A then proceeds through a per-file evaluation for each enabled detection type.

For a given image file and detection type, flowchart 100A proceeds to a processed decision 111. In some embodiments, processed decision 111 checks whether the image file has already been processed for that detection type using a per-file×per-detection-type processed flag stored in the local cache, such as processed:{client}:{event}:{dtype}:{filename}. If processed decision 111 indicates the file is already processed for that detection type (and configuration unchanged flag does not require reprocessing), flowchart 100A proceeds to a skip 112 to avoid resending the file to expensive downstream processing for that detection type.

If processed decision 111 indicates the file needs work for that detection type (e.g., because the file is new/unprocessed or because processed flags were cleared due to configuration changed), flowchart 100A proceeds to an add to queue 113. In some embodiments, add to queue 113 adds the image file to a per-detection-type queue, such as files_to_process[dtype], so that downstream processing can run one detection type at a time. In some embodiments, the detection types include object, logo, text, jersey, facial, and credential, and each detection type uses its own detector within a model-agnostic loop that preserves the same surrounding control flow for each detection type.

In some embodiments, the queue generated by add to queue 113 is subsequently processed downstream via connector B using one detection type at a time, which can bound GPU memory usage and maintain a predictable pipeline. Accordingly, FIG. 1A illustrates an example upstream scanning workflow that reduces redundant processing by (i) skipping non-actionable specified events, (ii) skipping deactivated detection types before images are loaded, (iii) using per-event per-detection-type configuration snapshots to determine whether configuration changed without loading images, and (iv) using per-file×per-detection-type processed flags to prevent files from being repeatedly queued, while still enabling controlled reprocessing when configuration changed and supporting distributed processing by partitioning detection types across scanner instances.

Continuing to FIG. 1B, FIG. 1B shows a flowchart 100B illustrating an example control flow for efficient image scanning with configuration change detection, detection cache lookup, and model-agnostic processing that reduces computationally expensive AI operations by avoiding repetitions of a run AI model inference 123 for a given image file and detection type.

A queued files decision 114 determines whether any image files are queued for processing for an event. In some embodiments, queued files decision 114 is evaluated after a scanner discovers events by walking a directory tree to find client/event folders and, for each event, identifies image files that are new or unprocessed for one or more detection types. When queued files decision 114 indicates no queued files, a skip 115 skips processing for that event, thereby avoiding image loading and AI processing for events that are up-to-date.

A process event 116 initiates processing for the event when queued files decision 114 indicates that queued files are present. In some embodiments, process event 116 creates an analytics run record in an analytics database and prepares resources used for sequential processing across detection types, such as opening a local cache or KV cache for detection results and processing flags. In some embodiments, process event 116 further initializes event-specific configuration used to determine actionable detections, including whether particular detection types are enabled and configured to write tags or favorites.

A model-agnostic loop 117 iterates for respective detection types and applies a common surrounding process to different detection types, thereby supporting module-agnostic integration of multiple AI modules. In some embodiments, model-agnostic loop 117 sequentially processes object detection, logo detection, text detection, jersey recognition, facial recognition, and credential detection, with each detection type instantiating its own detector while sharing common steps for change detection and caching. In some embodiments, sequential processing within model-agnostic loop 117 bounds GPU memory usage and makes processing predictable, while still allowing distributed processing by running multiple scanner instances with different detection types disabled.

A config change check 118 evaluates whether configuration for a particular detection type has changed relative to a previously stored configuration snapshot. In some embodiments, config change check 118 compares a current configuration for the detection type against a stored configuration in the local cache or KV cache using a lightweight comparison that does not load images, and produces a result indicating whether to process image files previously processed under a prior configuration (e.g., when configuration changed) or to process new or unprocessed image files (e.g., when configuration unchanged). In some embodiments, config change check 118 is used in conjunction with processing flags such that, when configuration changes, processing flags for the detection type are cleared so that image files can be re-evaluated under updated event-level criteria.

A resize image 119 prepares each image file for detection processing. In some embodiments, resize image 119 reads an image file from shared image storage and resizes the image to an upper dimension limit or to processing dimensions suitable for a corresponding detection model, thereby reducing compute, memory, and latency while preserving features used by object detection, text recognition, jersey recognition, facial recognition, credential detection, and logo detection.

A detection cache lookup 120 checks a detection result cache for a previously stored detection result for a current image file and detection type. In some embodiments, detection cache lookup 120 queries the local cache or KV cache using a cache identifier derived from the detection type and path components of the image file, such as last path segments of a directory structure associated with the event, thereby allowing reuse of prior detection results across scan cycles and across configuration changes.

A cache hit decision 121 determines whether detection cache lookup 120 found a cached detection result. When cache hit decision 121 indicates a cache hit, return cached result 122 returns the cached detection result without performing run AI model inference 123. In some embodiments, return cached result 122 deserializes stored detections and sets an inference time indicator to zero, while still allowing subsequent processing (e.g., user filtering) to be re-executed using updated event-level criteria. In this way, cache hit decision 121 and return cached result 122 provide a layer of efficiency that is independent of processing flags.

When cache hit decision 121 indicates a cache miss, run AI model inference 123 executes a detection model on the resized image. In some embodiments, run AI model inference 123 uses GPU-accelerated vision models, including one or more of YOLO, DETR, FaceNet, EasyOCR, DINOv2, or a vision language model server, depending on the detection type. In some embodiments, run AI model inference 123 generates raw detections such as object classes, logo matches, recognized text, jersey numbers and colors, face embeddings, or credential detections, which can later be matched against user filtering rules. In some embodiments, the generated raw detections include intermediate data in addition to final classifications, such as facial embeddings or other feature representations, such that later comparisons can be performed against newly added reference data without rerunning the underlying image analysis model on previously processed images.

A store in cache 124 stores results produced by return cached result 122 or run AI model inference 123 to the detection result cache for future reuse. In some embodiments, store in cache 124 serializes a detection result and writes the detection result to the local cache or KV cache under a cache identifier associated with the detection type and image file, thereby enabling subsequent scans to avoid repeating run AI model inference 123 even when image files are queued due to configuration changes. In some embodiments, store in cache 124 cooperates with processing flags such that a file can be marked processed for a detection type after logging and writing results, including writing tags (including EXIF metadata) and favorites via an API when actionable detections are identified. Flowchart 100B may continue at connector C.

Continuing to FIG. 1C, FIG. 1C shows a flowchart 100C for a portion of an image scanning process that can be performed after raw detections have been obtained for an image file under a selected detection type within an event. In particular, flowchart 100C can be executed within nested processing scopes such as for each event, for each detection type, and for each image file, such that a same model-agnostic processing structure can be reused across object detection, logo detection, text detection, jersey recognition, facial recognition, and credential detection. In some embodiments, flowchart 100C represents a downstream portion of a larger processing pipeline (e.g., FIGS. 1A and 1B) in which AI model inference is performed only when needed, and the operations shown in FIG. 1C can convert raw detections into actionable detections, persistent outputs, and completion state information for later scan cycles.

An apply user filtering 125 can receive raw detections generated for an image file and can evaluate the raw detections against the user's event-specific criteria to determine whether any of the detections are actionable detections. For example, apply user filtering 125 can match raw detections against jersey number criteria, color match criteria, allowed object classes, face embedding distance criteria, text search terms, logo-related criteria, or credential-related criteria, depending on the detection type being processed. In some embodiments, apply user filtering 125 is performed even when a detection result cache provides a previously stored detection result, such that a configuration change can cause filtering to be re-executed without requiring repeated AI model inference. In this way, apply user filtering 125 can allow the system to preserve efficiency while still adapting outputs to updated event configuration settings. In some embodiments, raw detections become actionable detections only when the raw detections satisfy one or more event-specific criteria defined through an administrative interface, such as target faces, jersey numbers, jersey colors, text terms, object classes, logos, credentials, or combinations thereof.

A log and write results 126 can receive filtering results from apply user filtering 125 and can write one or more outputs associated with matching detections. For example, log and write results 126 can record detection analytics in an analytics database, including timing, counts, details, and run history associated with the current image file, event, and detection type. Additionally, or alternatively, log and write results 126 can write tags (e.g., to embedded image metadata and/or platform-managed metadata, including EXIF metadata) and/or favorites through an API such that resulting metadata persists across platforms and applications and remains searchable in near real time. In some embodiments, where credential detection identifies badge information or where text detection, facial recognition, logo detection, object detection, or jersey recognition produces a qualifying match, log and write results 126 can write corresponding tags or favorites for later retrieval by an admin system, browser-based interface, application, or kiosk environment.

A mark file processed 127 can be performed after log and write results 126 to store completion state information indicating that the image file has been processed for the current detection type. In some embodiments, mark file processed 127 sets a processed flag in a local cache or KV cache on a per-file, per-detection-type basis, thereby preventing the image file from being re-entered into the same processing path during a later scan cycle when the applicable configuration remains unchanged. For example, mark file processed 127 can store a processed state keyed by client, event, detection type, and filename. In some embodiments, if a later configuration change occurs for that detection type, previously stored processed flags can be cleared so that the image file can be re-evaluated under revised filtering criteria while still permitting reuse of previously cached intermediate data or detection results.

A finalize run 128 can be performed after a set of image files has been processed for a given run, and can update an analytics run record with completion time, file counts, and error counts. In some embodiments, finalize run 128 occurs after repeated execution of apply user filtering 125, log and write results 126, and mark file processed 127 across multiple image files and, in some instances, across multiple detection types for an event. For example, finalize run 128 can close out a run record that was created at the beginning of detection processing and can thereby preserve a persistent history of scanner activity for monitoring throughput, diagnosing failures, and evaluating efficiency gains produced by processing flags and result caching.

A cleanup 129 can be performed after finalize run 128 to release resources used during the run. In some embodiments, cleanup 129 includes releasing GPU memory and closing database connections, and can further include closing or flushing cache-related resources, clearing model state, or otherwise preparing the scanner for a next event, a next detection type, or termination of the current scan process. In some embodiments, because the overall architecture processes one detection type at a time, cleanup 129 can help bound GPU memory usage and keep the processing pipeline simple and predictable. In this way, flowchart 100C can support a module-agnostic and pluggable detection modules architecture in which intermediate data, embeddings, detection result cache entries, processing flags, and output-writing operations are coordinated to reduce redundant processing while maintaining accurate, event-specific tagging behavior.

Turning now to FIG. 2, FIG. 2 shows a diagram 200 of a distributed, AI-driven image analysis architecture including a shared image storage 210, a server A 220A, a server B 220B, and shared services 240. As shown, shared image storage 210 can store event image galleries on a shared file system that is mounted by multiple server systems, such that server A 220A and server B 220B can read images from the same underlying image corpus while operating as independent scanner instances. In some embodiments, server A 220A and server B 220B both run the same scanner program, and the distributed behavior of diagram 200 is produced by a configuration setting that assigns disabled types and assigned types differently across the respective servers rather than by requiring different executable code on a per-server basis. In this way, diagram 200 can provide a model-agnostic or module-agnostic architecture in which multiple detection types are partitioned across multiple servers to increase throughput, while preserving change detection, caching, and other efficiency mechanisms for the respective servers.

Shared image storage 210 can be configured to provide image data to server A 220A and server B 220B for processing of the same event image galleries. In some embodiments, shared image storage 210 corresponds to network-attached storage, cloud-backed storage presented as a mounted file system, or another shared repository that exposes the same directory structure to the respective scanner instances. Because server A 220A and server B 220B can access the same event image galleries, server A 220A and server B 220B can contribute additive results to the same set of images, with a given server handling processing that is limited to its assigned types. For example, one server can be configured to perform object detection, facial recognition, text recognition, and credential detection, while another server can be configured to perform jersey recognition and logo recognition, such that no two servers perform duplicated AI model inference for the same detection types on the same images.

As illustrated in FIG. 2, server A 220A can be configured to execute a first subset of detection types and, in the illustrated example, includes an object detection 222A, a facial recognition 224A, a text recognition 226A, a credential detection 228A, and have disabled a jersey recognition 230A, and a logo recognition 232A. In some embodiments, object detection 222A can identify user-selected objects appearing in images, such as sports equipment, environmental features, or other detectable objects, and can generate detection results that can later be filtered according to event-related criteria. Facial recognition 224A can detect faces and compare extracted facial information against previously stored facial data to support tagging and sorting of photos based on individuals. Text recognition 226A can extract alphanumeric content from images, including names, labels, signs, or numbers appearing within a scene, while credential detection 228A can detect a badge, pass, or other credential and can extract associated text for metadata generation, security review, or subsequent blurring on a public-facing side of a photo management platform.

Jersey recognition 230A can be configured to identify jersey characteristics including a jersey number, a jersey color, or combinations thereof, which can be useful in sports environments where facial recognition can be less reliable, such as when subjects are wearing helmets or other face coverings. Logo recognition 232A can be configured to detect client-related or event-related logos appearing in images, including sponsor logos, institutional logos, or branded graphical marks previously provided to the system. In some embodiments, one or more of object detection 222A, facial recognition 224A, text recognition 226A, credential detection 228A, jersey recognition 230A, and logo recognition 232A can use GPU-accelerated vision models, a vision language model server, or other AI model inference resources, while surrounding control flow remains the same for each detection type. For example, a given detection type can have its own detection results, processing flags, and cache keys, even though server A 220A processes the enabled types sequentially to bound resource consumption and maintain predictable operation.

Server B 220B can correspond to server A 220A in overall structure and can likewise include an object detection 222B, a facial recognition 224B, a text recognition 226B, a credential detection 228B, a jersey recognition 230B, and a logo recognition 232B, corresponding to similar functional categories across the two servers. In some embodiments, object detection 222B corresponding to object detection 222A, facial recognition 224B corresponding to facial recognition 224A, text recognition 226B corresponding to text recognition 226A, credential detection 228B corresponding to credential detection 228A, jersey recognition 230B corresponding to jersey recognition 230A, and logo recognition 232B corresponding to logo recognition 232A can be present within the same scanner program executed by server B 220B, but a configuration setting can designate one or more of those detection types as disabled types on server B 220B. As illustrated, server B 220B can be configured to actively process a different subset of assigned types than server A 220A (e.g., jersey recognition 230B being enabled whereas the other detection types disabled), thereby allowing the overall system to distribute workload in the absence of distributed locking, message queues, or inter-server communication.

In some embodiments, the use of server A 220A and server B 220B permits non-overlapping detection types to be processed concurrently for the same event image galleries. For example, server A 220A can process object detection 222A, facial recognition 224A, text recognition 226A, and credential detection 228A while server B 220B processes jersey recognition 230B. In the example of FIG. 2, logo recognition 232A and logo recognition 232B may both be disabled. Alternatively, the distribution of assigned types can be changed over time to rebalance workload, add a new server, or remove a server, while the underlying scanner program remains unchanged. Because a given server can maintain a local cache for its assigned types, with caching limited to those assigned types, there can be no cache conflict between server A 220A and server B 220B when the assigned types do not overlap. As a result, a given server can preserve detection results and processing flags independently, allowing previously analyzed images to avoid repeated AI model inference even after later changes to user filtering criteria, and allowing new or unprocessed files to be identified efficiently during subsequent scan cycles. Because the assigned detection types are non-overlapping and each server maintains local cache entries for its assigned detection types, the distributed architecture can operate without distributed locking, message queues, or inter-server coordination for overlapping image analysis work.

Shared services 240 can receive write results operations from server A 220A and server B 220B and can serve as shared output targets for the distributed architecture. In the illustrated embodiment, shared services 240 include an analytics database 242 and a tags and favorites API 244. Analytics database 242 can log detection results, timing, counts, details, error counts, and run history from multiple servers, thereby providing a consolidated analytical view of operation of the distributed system. In some embodiments, analytics database 242 can store run records indicating when processing started and completed for a given event, which detection types were executed, and how many files were processed, skipped, or matched.

Tags and favorites API 244 can receive actionable results from server A 220A and server B 220B and can write tags, favorites, and associated EXIF metadata for images that satisfy user-defined criteria. For example, if text recognition 226A identifies a desired alphanumeric string, if jersey recognition 230B identifies a specified jersey number and jersey color, and/or if logo recognition 232A or logo recognition 232B identifies a selected sponsor logo, tags and favorites API 244 can persist corresponding tags to make the associated images searchable across a browser, app, kiosk, or other platform endpoint. In some embodiments, results written through tags and favorites API 244 are additive, such that different servers can contribute different tags or favorites for the same image without overwriting one another. In this way, shared services 240 can unify outputs from distributed scanner instances while shared image storage 210 remains the common image source and server A 220A and server B 220B remain independently configurable processing nodes.

FIG. 3 shows a distributed processing system workload distribution in which a processing timeline 300, a processing timeline 302, and a processing timeline 304 illustrate example allocations of detection types across one or more scanner instances running on different servers. In particular, processing timeline 300 represents a sequential arrangement in which an object detection 322, a facial recognition 324, a text recognition 326, a credential detection 328, a jersey recognition 330, and a logo recognition 332 are performed by a single server, while processing timeline 302 and processing timeline 304 represent concurrent arrangements in which non-overlapping detection types are partitioned across multiple servers to maximize throughput. In some embodiments, the servers execute the same program with different configuration settings that specify disabled detection types, such that each server operates on assigned types while reading from shared image storage and writing additive results to shared services, such as an analytics database and a tags/favorites API (in FIG. 2). In this way, the distributed processing system can preserve a model-agnostic, single-detection-at-a-time architecture while reducing wall-clock time and avoiding duplicated AI work.

Processing timeline 300 can correspond to a baseline arrangement in which all enabled detection types are executed sequentially on one server. For example, object detection 322 can identify user-specified objects in event images, facial recognition 324 can detect and recognize faces for tagging and sorting, text recognition 326 can detect and recognize alphanumeric content, credential detection 328 can detect credentials or badges and extract text associated with metadata, jersey recognition 330 can distinguish jerseys by attributes such as number and color, and logo recognition 332 can detect logos uploaded or otherwise specified by a client. In some embodiments, these detection types are processed one at a time to bound GPU memory usage and keep the processing pipeline predictable. This arrangement can correspond to a configuration in which one scanner instance maintains local cache entries, detection results, and processing flags for all of the detection types handled by the server.

Processing timeline 302 can correspond to a two-server arrangement in which work is partitioned between a first server and a second server. In particular, object detection 322A, corresponding to object detection 322, facial recognition 324A, corresponding to facial recognition 324, text recognition 326A, corresponding to text recognition 326, and credential detection 328A, corresponding to credential detection 328, can be assigned to the first server, while jersey recognition 330B, corresponding to jersey recognition 330, and logo recognition 332B, corresponding to logo recognition 332, can be assigned to the second server. Because the assigned detection types are non-overlapping, each server can skip its disabled detection types before images are loaded, thereby providing zero duplicated AI work without distributed locking, message queues, or inter-server communication. In some embodiments, the first server and the second server each maintain a separate local cache for detection results and processing flags associated with their respective assigned types while still reading the same image files from a shared file system and writing results through common output interfaces.

An idle period 334A in processing timeline 302 can indicate that the first server completes object detection 322A, facial recognition 324A, text recognition 326A, and credential detection 328A before the second server completes jersey recognition 330B and logo recognition 332B, or vice versa in other workload allocations. Similarly, an idle period 334B can indicate unused processing time on the second server after completion of jersey recognition 330B and logo recognition 332B. In some embodiments, idle period 334A and idle period 334B can be used to evaluate whether the partitioning of detection types is balanced across the servers. For example, if idle period 334A is substantially longer than idle period 334B, the configuration can be adjusted so that one or more detection types are reassigned between servers to improve balance and further reduce wall-clock time. Alternatively, a deployment can retain a partially unbalanced configuration to reserve compute capacity for burst traffic, for newly enabled detection types, or for event-specific workloads that vary over time.

Processing timeline 304 can correspond to a three-server arrangement that further segments the detection types over time and across servers. In particular, object detection 322A, corresponding to object detection 322, text recognition 326A, corresponding to text recognition 326, and credential detection 328A, corresponding to credential detection 328, can be assigned to a first server, jersey recognition 330B, corresponding to jersey recognition 330, can be assigned to a second server, and facial recognition 324C, corresponding to facial recognition 324, and logo recognition 332C, corresponding to logo recognition 332, can be assigned to a third server. In some embodiments, this allocation can be selected because facial recognition and logo recognition have different computational characteristics than object detection, text recognition, credential detection, or jersey recognition, and distributing those detection types across three servers can better balance use of GPU-accelerated vision models and any vision language model server used by one or more of the detection types. In this way, the same scanner program can scale horizontally by changing configuration rather than changing underlying control flow.

Idle period 334A in processing timeline 304 can indicate unused time after the first server completes object detection 322A, text recognition 326A, and credential detection 328A. Idle period 334B can indicate unused time after the second server completes jersey recognition 330B. Idle period 334C can indicate unused time after the third server completes facial recognition 324C and logo recognition 332C. In some embodiments, idle period 334A, idle period 334B, and idle period 334C provide a visual representation of throughput balance among the servers and can be used when selecting which detection types to disable on each server. For example, a deployment can move facial recognition from the first server to the third server, as shown by facial recognition 324C relative to facial recognition 324A, to reduce a bottleneck that would otherwise arise if the first server handled both face-related processing and other detection types. Similarly, logo recognition 332C can be grouped with facial recognition 324C, or alternatively with jersey recognition 330B or with object detection 322A, depending on measured run history, timing, and resource availability.

Object detection 322, object detection 322A, facial recognition 324, facial recognition 324A, facial recognition 324C, text recognition 326, text recognition 326A, credential detection 328, credential detection 328A, jersey recognition 330, jersey recognition 330B, logo recognition 332, logo recognition 332B, and logo recognition 332C can each represent a discrete detection type that uses its own AI model while remaining within the same surrounding process. In some embodiments, each detection type has its own processing flags and its own cache keys, such that a file that has already been processed for one detection type need not be re-sent to an expensive AI model for that detection type unless configuration changes. For example, if a new matching criterion is added for facial recognition or logo recognition after prior scanning, cached detection results can be reused and only user filtering can be re-executed with the new criteria. Likewise, jersey recognition can process jersey number and color combinations, credential detection can support badge-related security workflows including selective blurring on a public-facing side, and text recognition can support searching and tagging based on names, numbers, or other alphanumeric content. Because the detection types remain independent at the control-flow level, new detection modules can be added in a model-agnostic manner and partitioned across additional servers in the same way.

Processing timeline 300, processing timeline 302, and processing timeline 304 can illustrate that shared image storage and shared output targets allow multiple scanner instances to contribute additive results to the same images without requiring shared state for overlapping detection work. In some embodiments, each server reads images from identical directory structures, maintains only the local cache entries needed for its assigned types, records run history and detection analytics in the analytics database, and writes tags, favorites, and EXIF metadata through common API endpoints. For example, one server can process object detection and credential detection while another server processes jersey recognition and a third server processes facial recognition and logo recognition, all in near real time for the same event galleries. This can allow administrators to turn detection types on and off as needed for different sports events, corporate events, security applications, or media workflows while preserving efficient scanning and scalable deployment. In some embodiments, because the scanner instances process non-overlapping detection types and maintain separate local caches for their assigned detection types, the scanner instances need not exchange locking information or coordinate overlapping inference tasks while still contributing additive outputs for the same image data.

FIG. 4 shows a system 400 for implementing the event discovery, change detection, queued processing, cache-based reuse, sequential model handling, distributed execution, and result generation described with respect to FIGS. 1A-3. In the illustrated embodiment, system 400 includes memory 440 storing modules 402 and data elements 420, and further includes physical processor 430 for executing one or more of modules 402 to perform image analysis in near real time, including generating tags and favorites and writing tags including EXIF metadata. In some embodiments, system 400 is configured to perform the flow operations shown in FIG. 1A (e.g., 101-113), the processing operations shown in FIG. 1B (e.g., 114-124), the output operations shown in FIG. 1C (e.g., 125-129), the distributed architecture shown in FIG. 2, and the staged timing and partitioned execution shown in FIG. 3.

Modules 402 include an image module 404, a processing module 406, an AI module 408, and a metadata module 410. In some embodiments, image module 404 corresponds to the image acquisition, initial processing, and image accessing functionality introduced in the earlier figures, and is configured to receive or access image data 422 from one or more sources, including direct camera transfer, mobile upload, satellite feed, drone imagery, and shared image storage. In some embodiments, the one or more sources include shared event image storage and one or more upload interfaces through which images are uploaded for event or project processing. In some embodiments, image module 404 performs operations corresponding to initialize 101, scan directory tree 102, scan 105, scan directories 110, and resize image 119 by discovering client and event folders, locating image galleries, loading image files, performing format standardization, performing quality check, extracting available metadata, and preparing image data 422 for downstream processing. Thus, image module 404 can perform the image acquisition and file discovery described above.

In some embodiments, processing module 406 corresponds to the decision, control, and orchestration functionality described above, including actionable decision 103, disabled decision 106, config change check 108 and 118, flag for processing 109, processed decision 111, add to queue 113, queued files decision 114, process event 116, model-agnostic loop 117, apply user filtering 125, mark file processed 127, finalize run 128, and cleanup 129. In some embodiments, processing module 406 acts as a model identifying module, a model selector, a model queue controller, and a model coordinator by determining which one or more of a plurality of available image analysis models are to be implemented for a specified event, determining whether a detection type is deactivated, selecting files for processing, and controlling one detection type at a time in a predictable sequence. In this manner, processing module 406 provides the processor-executed control structure configured for the resource-aware workflow and one-at-a-time execution reflected in FIG. 3.

In some embodiments, processing module 406 further implements the distributed processing concepts shown in FIG. 2 by allowing different instances of system 400 to operate on the same image corpus while handling different detection types. For example, separate instances of system 400 can correspond to servers 220A and 220B, while image data 422 can correspond to shared image storage 210, processing status 424 can store run-state and assignment information associated with shared services 240, metadata 428 can be delivered through tags and favorites API 244, and processing results and timing information can be recorded in an analytics database corresponding to analytics database 242. In some embodiments, because each instance stores cached data 426 for its assigned detection types, the multiple instances can operate independently without overlapping AI work while still contributing additive results for the same underlying images.

AI module 408 is configured to instantiate and execute one or more artificial intelligence (AI) models or machine learning (ML) models on image data 422 and corresponds to the main model execution described above. In some embodiments, AI module 408 implements operations corresponding to detection cache lookup 120, cache hit decision 121, return cached result 122, run AI model inference 123, and store in cache 124. In some embodiments, AI module 408 selectively invokes an object detection model, an alphanumeric recognition model, a facial recognition model, a graphic or logo detection model, and additional image analysis models such as jersey recognition or credential detection, depending on the determination made by processing module 406. In some embodiments, AI module 408 also cooperates with processing module 406 and cached data 426 to support the partitioned model activity represented in FIG. 3, such that different model types may be executed by different system instances or during different scheduled intervals while preserving the same surrounding control flow.

In some embodiments, cached data 426 provides the physical data-store implementation for the two efficiency layers described above. For example, cached data 426 can include per-file, per-detection-type processing flags corresponding to processed decision 111 and mark file processed 127, and can further include detection result cache entries corresponding to detection cache lookup 120, cache hit decision 121, return cached result 122, and store in cache 124. In some embodiments, these cached structures allow processing module 406 to avoid re-queuing files that have already been completed and allow AI module 408 to avoid repeating expensive inference for images that were previously analyzed, even when updated event-specific criteria cause the filtering stage to be performed again.

In some embodiments, metadata module 410 corresponds to the result formation and output handling reflected in the earlier figures and is configured to generate, update, classify, and persist metadata 428 associated with image data 422. In some embodiments, metadata module 410 implements log and write results 126 by writing tags including EXIF metadata, writing favorites, storing searchable metadata information, and supporting category assignment and relation mapping for later retrieval. In some embodiments, metadata module 410 cooperates with processing module 406 so that raw model outputs become actionable results only after event-specific rules are applied, thereby providing a physical implementation of the transition from model output to user-facing organization and access functions. In some embodiments, metadata 428 is persisted in both embedded image metadata, including EXIF metadata, and separate platform-managed metadata stores, such that searchability and portability are preserved across different applications, interfaces, and workflows.

In some embodiments, metadata module 410 may further cause modifications to image data 422 based on metadata 428 and applicable configuration rules. For example, metadata module 410 may redact or blur sensitive credential information, embed or update metadata within an image file, adjust color consistency, apply softening, or perform blemish removal for selected image sets.

Data elements 420 include image data 422, processing status 424, cached data 426, and metadata 428. In some embodiments, image data 422 stores the one or more images accessed from local galleries, remote sources, or shared image storage. In some embodiments, processing status 424 stores event-level, file-level, and detection-type status information representing whether work has been skipped, queued, started, completed, finalized, or deactivated, and further indicating whether a stored prior analysis result is available for a given image and image analysis operation type. In some embodiments, processing status 424 is maintained together with configuration snapshots or hashes used to determine whether event-specific processing criteria have changed. In some embodiments, cached data 426 stores local cache entries, processing flags, and prior inference outputs used to support model-agnostic processing across repeated scan cycles. In some embodiments, metadata 428 stores image tags, favorites, EXIF metadata, category information, relation mapping information, and references that make resulting image data searchable according to keywords or phrases.

In some embodiments, physical processor 430 executes modules 402 from memory 440 such that the workflows described herein are carried out by a physical computer architecture. For example, image module 404 can implement acquisition and preparation tasks, processing module 406 can implement event logic and model selection logic, AI module 408 can implement selected model inference and cache-aware result reuse, and metadata module 410 can implement tag generation and output persistence. Accordingly, FIG. 4 illustrates how the operations, timing behavior, and distributed arrangements introduced in FIGS. 1A-3 may be implemented in memory-resident software modules, processor-executed instructions, and stored data structures within one or more computing systems 400.

FIG. 5 illustrates an example system 500 in which a computing device 502 is communicatively coupled to a server 506 via a network 504. In some embodiments, the server 506 may represent one or more servers configured to provide image analysis services for the computing device 502. As shown, computing device 502 and server 506 may each include one or more modules 402, one or more data elements 420, physical processor 430, and memory 440.

In some embodiments, the computing device 502 may be configured to initiate, manage, and/or receive results associated with one or more image analysis tasks. For example, computing device 502 may provide image data, configuration information, user inputs, and/or other information to the server 506 via network 504. In some embodiments, computing device 502 may also receive image metadata, image tags, processing status information, and/or categorized image information generated by the server 506.

In some embodiments, server 506 may implement one or more image accessing modules, one or more model identifying modules, one or more instantiation modules, and one or more image data generating modules as part of modules 402. For example, server 506 may access one or more images, identify which one or more of a plurality of available image analysis models are to be implemented to perform one or more image analysis tasks related to the one or more images, instantiate the identified image analysis models, and generate image metadata associated with the one or more images. In some embodiments, the generated image metadata may include metadata information, image tags, categorized image information, and/or searchable information associated with a specific object or person and/or a specified event. In some embodiments, an administrative interface is used to define or update the specified event configuration, including enabling or disabling one or more image analysis operation types and specifying which outputs (e.g., tags or favorites) are to be written when actionable detections occur. In some embodiments, the administrative interface is further used to upload one or more logos to be detected for the specified event. In some embodiments, the administrative interface accepts criteria specifying one or more target faces, jersey numbers, jersey colors, text terms, object classes, logos, credentials, or combinations thereof for a specified event.

In some embodiments, server 506 may implement one or more artificial intelligence (AI) models and/or machine learning (ML) models to perform the image analysis tasks. For example, server 506 may selectively implement one or more of an object detection model, an alphanumeric recognition model, a facial recognition model, a color recognition model, a graphic or logo detection model, a jersey recognition model, a credential detection model, AI-generated captioning model, an anomaly detection model, and/or a content masking model. In some embodiments, one or more of the available image analysis models may be deactivated such that server 506 implements a selected subset of the plurality of available image analysis models for a particular image analysis task, a specific object or person, and/or a specified event. In some embodiments, credential detection identifies credential information and causes redaction or blurring of sensitive information in a public-facing workflow while maintaining unredacted images for authorized access.

In some embodiments, memory 440 of the computing device 502 and/or server 506 may store computer-executable instructions for modules 402 and may further store one or more data elements 420. Data elements 420 may include, for example, image data 422, processing status 424, cached data 426, metadata 428, and/or other information associated with processing one or more images. In some embodiments, physical processor 430 of the computing device 502 and/or server 506 may execute modules 402 to perform one or more of the functions described herein.

Network 504 generally represents any medium or architecture capable of facilitating communication or data transfer. In one example, network 504 may facilitate communication between computing device 502 and server 506 and includes one or more communications links via which the computing device 502 and the server 506 exchange image data, configuration data, processing status data, and/or metadata. In this example, network 504 may facilitate communication or data transfer using wireless and/or wired connections. Examples of network 504 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network. Network 504 may support communication of image data, configuration information, processing requests, image metadata, image tags, and/or other information between computing device 502 and server 506. In some embodiments, when server 506 represents a plurality of servers, the plurality of servers may collectively perform the image analysis tasks associated with one or more images.

FIG. 6 illustrates a method 600 for real-time AI-driven image analysis that may be performed by system 400. Method 600 may be used to access one or more images, identify which one or more of a plurality of available image analysis models are to be implemented to perform one or more image analysis tasks related to the accessed images, instantiate the one or more identified image analysis models to perform the one or more image analysis tasks related to the accessed images, and generate image metadata associated with the one or more images, wherein each of the identified image analysis models provides different metadata information related to the accessed images.

At step 602, system 400 may receive image data having a corresponding processing configuration. In some embodiments, image module 404 may access one or more images represented by image data 422 from a specified data store in memory 440 or from another source coupled to system 400. In some embodiments, the one or more images may be captured and transferred by a camera interface, including direct-from-camera transfer, and then accessed by image module 404 for further processing. The corresponding processing configuration may indicate a specified event, one or more enabled image analysis tasks related to the accessed images, one or more deactivated image analysis models, security or access parameters, and one or more criteria for generating image metadata. Thus, step 602 may provide support for accessing one or more images through image accessing module functionality implemented, for example, by image module 404 of modules 402.

At step 604, system 400 may identify a processing status for the received image data, the processing status indicating prior image analysis on the image data. In some embodiments, processing module 406 may generate or update processing status 424 based on whether the accessed images have previously been analyzed, whether cached data 426 is available, whether metadata 428 has already been generated, and whether the corresponding processing configuration has changed. In some embodiments, processing status 424 may indicate whether one or more image analysis tasks related to the accessed images have already been completed for a specified event, whether one or more available image analysis models have previously been implemented, and whether at least a portion of the image data 422 is to be reprocessed. In this manner, step 604 may identify a current state of image data 422 before additional model selection and instantiation are performed.

At step 606, system 400 may determine, from the processing status and the processing configuration, one or more image analysis operations to be performed to create metadata for the image data. In some embodiments, processing module 406 may operate as a model identifying module configured to identify which one or more of a plurality of available image analysis models are to be implemented to perform one or more image analysis tasks related to the accessed images. For example, based on image data 422, processing status 424, and/or cached data 426, processing module 406 may identify that an object detection model, an alphanumeric recognition model, a facial recognition model, a color recognition model, a graphic or logo detection model, an anomaly detection model, a content masking model, or any combination thereof is to be implemented. In some embodiments, one or more of the available image analysis models may be deactivated and not used for analyzing images associated with the specified event. In some embodiments, multiple different image analysis models are selected to identify different features of the same object or person, or to identify a specific object or person at the specified event. Accordingly, step 606 may include identifying which one or more of the plurality of available image analysis models are to be implemented and which one or more image analysis tasks related to the accessed images are to be performed.

At step 608, system 400 may coordinate one or more artificial intelligence (AI) models to perform the one or more image analysis operations and create the metadata. In some embodiments, AI module 408 may operate as an instantiation module configured to instantiate the one or more identified image analysis models to perform the one or more image analysis tasks related to the accessed images. For example, AI module 408 may selectively load, activate, instantiate, schedule, and execute the identified artificial intelligence (AI) models or machine learning (ML) models using physical processor 430 and memory 440. In some embodiments, AI module 408 may instantiate multiple specialized models in a coordinated manner so that different models analyze image data 422 for different types of content, including a specific object or person, alphanumeric content, color features, graphic or logo content, anomalies, or content to be masked. In some embodiments, cached data 426 may be reused when available so that system 400 avoids unnecessary repeated execution while still performing the one or more image analysis tasks related to the accessed images. In some embodiments, each of the identified image analysis models provides different metadata information related to the accessed images, and the different metadata information may be aggregated by system 400 during or after coordinated model execution.

At step 610, system 400 may output the metadata for the image data. In some embodiments, metadata module 410 may operate as an image data generating module configured to generate image metadata associated with the one or more images using the different metadata information provided by the identified image analysis models. The generated metadata 428 may include image tags, category information, search information, security designations, or other image metadata associated with the one or more images. In some embodiments, the image tags generated by the identified image analysis models are searchable according to at least one of keywords or phrases. In some embodiments, system 400 may further categorize the one or more images based on the different metadata information provided by the identified image analysis models. Metadata 428 may be stored in memory 440, associated with image data 422, transmitted to another component, or made available through one or more interfaces, as described herein. In this way, step 610 may provide explicit support for generating image metadata associated with the one or more images after the identified image analysis models have been implemented and instantiated by system 400.

As detailed above, in some embodiments, image data can be processed according to a configurable workflow in which different categories of image analysis are selectively applied based on information associated with the image data and based on a processing configuration applicable to the image data. The processing configuration may be established for a particular event, project, customer, use case, or other grouping of images, and may define which image analysis operations are relevant for the associated images. A computing device may identify a processing status for a given image and, based on the processing status together with the processing configuration, may determine which image analysis operations remain to be performed, which image analysis operations have already been completed, and which previously generated analysis results may be used in lieu of repeating an image analysis operation.

In some embodiments, the disclosed systems may coordinate multiple artificial intelligence models that are respectively trained or otherwise configured to detect different types of content represented in image data. By way of example, different artificial intelligence models may be used for object detection, facial analysis, text recognition, color detection, graphic detection, logo detection, credential detection, or other image understanding tasks. The coordination of the artificial intelligence models may be centralized or distributed. In distributed implementations, different processing nodes may host different artificial intelligence models or different subsets of artificial intelligence models, and image analysis operations may be assigned across the processing nodes according to analysis type, model availability, computational capacity, memory availability, graphics-processing availability, or other execution criteria.

In some embodiments, the disclosed systems may improve processing efficiency by maintaining operation-specific status information and by reusing prior analysis results when appropriate. For example, where an image has already been analyzed for a given image analysis operation, the system may identify from the processing status that a corresponding prior analysis result is available and may use that prior analysis result without rerunning the corresponding artificial intelligence model. Such reuse may be beneficial when processing rules are changed after initial analysis, because the system may avoid repeating a completed detection operation and may instead apply updated filtering, tagging, classification, or output logic to an existing analysis result. In this manner, the disclosed systems may reduce redundant computation, lower processing latency, and improve throughput for high-volume image collections.

In some embodiments, metadata generated from the image analysis operations may be used in multiple ways. The metadata may identify content represented in the image data, such as persons, faces, objects, alphanumeric characters, colors, graphics, logos, credentials, or other detected features. The metadata may be output as tags, classifications, searchable descriptors, or other machine-readable information associated with the image data. In some implementations, the metadata may be written to embedded image metadata, including EXIF metadata, so that at least a portion of the generated information remains associated with the image data across different platforms or workflows. The metadata may also be used to classify images within a searchable catalog, to group images according to detected content, or to support downstream retrieval, access control, or workflow automation.

In some embodiments, the metadata and the applicable processing configuration may further be used to modify image data. For example, portions of an image may be obscured, redacted, highlighted, cropped, annotated, or otherwise modified based on detected content and configured rules. Sensitive information identified within the image data may be concealed, and embedded metadata may be created, updated, or supplemented based on the generated analysis results. The same underlying image analysis architecture may, in this way, support both descriptive outputs, such as tags and classifications, and action-oriented outputs, such as redaction, access management, or other image transformations.

In some embodiments, generated metadata may be validated before or after output. Validation may be performed by an additional artificial intelligence model, by rule-based logic, by user review, or by a combination thereof. A validator model may detect a discrepancy, inconsistency, or low-confidence condition in output of another artificial intelligence model, and corrective feedback may be generated in response. In some implementations, validation input received through a user interface may be used to modify metadata for a given image and may further be used as feedback for refining later metadata generation. As a result, the disclosed systems may support adaptable image-processing workflows that combine automated analysis, selective reuse of prior processing, distributed execution, and iterative quality improvement.

FIG. 7 is a block diagram of an example computing system 710 capable of implementing one or more of the embodiments described and/or illustrated herein. For example, all or a portion of computing system 710 may perform and/or be a means for performing, either alone or in combination with other elements, one or more of the steps described herein (such as one or more of the steps illustrated in FIG. 6). All or a portion of computing system 710 may also perform and/or be a means for performing any other steps, methods, or processes described and/or illustrated herein.

Computing system 710 broadly represents any single or multi-processor computing device or system capable of executing computer-readable instructions. Examples of computing system 710 include, without limitation, workstations, laptops, client-side terminals, servers, distributed computing systems, handheld devices, or any other computing system or device. In its most basic configuration, computing system 710 may include at least one processor 714 and a system memory 716.

Processor 714 generally represents any type or form of physical processing unit (e.g., a hardware-implemented central processing unit) capable of processing data or interpreting and executing instructions. In certain embodiments, processor 714 may receive instructions from a software application or module. These instructions may cause processor 714 to perform the functions of one or more of the example embodiments described and/or illustrated herein.

System memory 716 generally represents any type or form of volatile or non-volatile storage device or medium capable of storing data and/or other computer-readable instructions. Examples of system memory 716 include, without limitation, Random Access Memory (RAM), Read Only Memory (ROM), flash memory, or any other suitable memory device. Although not required, in certain embodiments computing system 710 may include both a volatile memory unit (such as, for example, system memory 716) and a non-volatile storage device (such as, for example, primary storage device 732, as described in detail below). In one example, one or more of modules 402 from FIG. 4 may be loaded into system memory 716.

In some examples, system memory 716 may store and/or load an operating system 740 for execution by processor 714. In one example, operating system 740 may include and/or represent software that manages computer hardware and software resources and/or provides common services to computer programs and/or applications on computing system 710. Examples of operating system 740 include, without limitation, LINUX, JUNOS, MICROSOFT WINDOWS, WINDOWS MOBILE, MAC OS, APPLE'S IOS, UNIX, GOOGLE CHROME OS, GOOGLE'S ANDROID, SOLARIS, variations of one or more of the same, and/or any other suitable operating system.

In certain embodiments, example computing system 710 may also include one or more components or elements in addition to processor 714 and system memory 716. For example, as illustrated in FIG. 7, computing system 710 may include a memory controller 718, an Input/Output (I/O) controller 720, and a communication interface 722, each of which may be interconnected via a communication infrastructure 712. Communication infrastructure 712 generally represents any type or form of infrastructure capable of facilitating communication between one or more components of a computing device. Examples of communication infrastructure 712 include, without limitation, a communication bus (such as an Industry Standard Architecture (ISA), Peripheral Component Interconnect (PCI), PCI Express (PCIe), or similar bus) and a network.

Memory controller 718 generally represents any type or form of device capable of handling memory or data or controlling communication between one or more components of computing system 710. For example, in certain embodiments memory controller 718 may control communication between processor 714, system memory 716, and I/O controller 720 via communication infrastructure 712.

I/O controller 720 generally represents any type or form of module capable of coordinating and/or controlling the input and output functions of a computing device. For example, in certain embodiments I/O controller 720 may control or facilitate transfer of data between one or more elements of computing system 710, such as processor 714, system memory 716, communication interface 722, display adapter 726, input interface 730, and storage interface 734.

As illustrated in FIG. 7, computing system 710 may also include at least one display device 724 coupled to I/O controller 720 via a display adapter 726. Display device 724 generally represents any type or form of device capable of visually displaying information forwarded by display adapter 726. Similarly, display adapter 726 generally represents any type or form of device configured to forward graphics, text, and other data from communication infrastructure 712 (or from a frame buffer, as known in the art) for display on display device 724.

As illustrated in FIG. 7, example computing system 710 may also include at least one input device 728 coupled to I/O controller 720 via an input interface 730. Input device 728 generally represents any type or form of input device capable of providing input, either computer or human generated, to example computing system 710. Examples of input device 728 include, without limitation, a keyboard, a pointing device, a speech recognition device, variations or combinations of one or more of the same, and/or any other input device.

Additionally or alternatively, example computing system 710 may include additional I/O devices. For example, example computing system 710 may include I/O device 736. In this example, I/O device 736 may include and/or represent a user interface that facilitates human interaction with computing system 710. Examples of I/O device 736 include, without limitation, a computer mouse, a keyboard, a monitor, a printer, a modem, a camera, a scanner, a microphone, a touchscreen device, variations or combinations of one or more of the same, and/or any other I/O device.

Communication interface 722 broadly represents any type or form of communication device or adapter capable of facilitating communication between example computing system 710 and one or more additional devices. For example, in certain embodiments communication interface 722 may facilitate communication between computing system 710 and a private or public network including additional computing systems. Examples of communication interface 722 include, without limitation, a wired network interface (such as a network interface card), a wireless network interface (such as a wireless network interface card), a modem, and any other suitable interface. In at least one embodiment, communication interface 722 may provide a direct connection to a remote server via a direct link to a network, such as the Internet. Communication interface 722 may also indirectly provide such a connection through, for example, a local area network (such as an Ethernet network), a personal area network, a telephone or cable network, a cellular telephone connection, a satellite data connection, or any other suitable connection.

In certain embodiments, communication interface 722 may also represent a host adapter configured to facilitate communication between computing system 710 and one or more additional network or storage devices via an external bus or communications channel. Examples of host adapters include, without limitation, Small Computer System Interface (SCSI) host adapters, Universal Serial Bus (USB) host adapters, Institute of Electrical and Electronics Engineers (IEEE) 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 722 may also allow computing system 710 to engage in distributed or remote computing. For example, communication interface 722 may receive instructions from a remote device or send instructions to a remote device for execution.

In some examples, system memory 716 may store and/or load a network communication program 738 for execution by processor 714. In one example, network communication program 738 may include and/or represent software that enables computing system 710 to establish a network connection 742 with another computing system (not illustrated in FIG. 7) and/or communicate with the other computing system by way of communication interface 722. In this example, network communication program 738 may direct the flow of outgoing traffic that is sent to the other computing system via network connection 742. Additionally or alternatively, network communication program 738 may direct the processing of incoming traffic that is received from the other computing system via network connection 742 in connection with processor 714.

Although not illustrated in this way in FIG. 7, network communication program 738 may alternatively be stored and/or loaded in communication interface 722. For example, network communication program 738 may include and/or represent at least a portion of software and/or firmware that is executed by a processor and/or Application Specific Integrated Circuit (ASIC) incorporated in communication interface 722.

As illustrated in FIG. 7, example computing system 710 may also include a primary storage device 732 and a backup storage device 733 coupled to communication infrastructure 712 via a storage interface 734. Storage devices 732 and 733 generally represent any type or form of storage device or medium capable of storing data and/or other computer-readable instructions. For example, storage devices 732 and 733 may be a magnetic disk drive (e.g., a so-called hard drive), a solid state drive, a floppy disk drive, a magnetic tape drive, an optical disk drive, a flash drive, or the like. Storage interface 734 generally represents any type or form of interface or device for transferring data between storage devices 732 and 733 and other components of computing system 710. In one example, data elements 420 from FIG. 4 may be stored and/or loaded in primary storage device 732.

In certain embodiments, storage devices 732 and 733 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 732 and 733 may also include other similar structures or devices for allowing computer software, data, or other computer-readable instructions to be loaded into computing system 710. For example, storage devices 732 and 733 may be configured to read and write software, data, or other computer-readable information. Storage devices 732 and 733 may also be a part of computing system 710 or may be a separate device accessed through other interface systems.

Many other devices or subsystems may be connected to computing system 710. Conversely, all of the components and devices illustrated in FIG. 7 need not be present to practice the embodiments described and/or illustrated herein. The devices and subsystems referenced above may also be interconnected in different ways from that shown in FIG. 7. Computing system 710 may also employ any number of software, firmware, and/or hardware configurations. For example, one or more of the example embodiments disclosed herein may be encoded as a computer program (also referred to as computer software, software applications, computer-readable instructions, or computer control logic) on a computer-readable medium. The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The computer-readable medium containing the computer program may be loaded into computing system 710. All or a portion of the computer program stored on the computer-readable medium may then be stored in system memory 716 and/or various portions of storage devices 732 and 733. When executed by processor 714, a computer program loaded into computing system 710 may cause processor 714 to perform and/or be a means for performing the functions of one or more of the example embodiments described and/or illustrated herein. Additionally or alternatively, one or more of the example embodiments described and/or illustrated herein may be implemented in firmware and/or hardware. For example, computing system 710 may be configured as an Application Specific Integrated Circuit (ASIC) adapted to implement one or more of the example embodiments disclosed herein.

FIG. 8 is a block diagram of an example network architecture 800 in which client systems 810, 820, and 830 and servers 840 and 845 may be coupled to a network 850. As detailed above, all or a portion of network architecture 800 may perform and/or be a means for performing, either alone or in combination with other elements, one or more of the steps disclosed herein (such as one or more of the steps illustrated in FIG. 6). All or a portion of network architecture 800 may also be used to perform and/or be a means for performing other steps and features set forth in the present disclosure.

Client systems 810, 820, and 830 generally represent any type or form of computing device or system, such as example computing system 710 in FIG. 7. Similarly, servers 840 and 845 generally represent computing devices or systems, such as application servers or database servers, configured to provide various database services and/or run certain software applications. Network 850 generally represents any telecommunication or computer network including, for example, an intranet, a WAN, a LAN, a PAN, or the Internet. In one example, client systems 810, 820, and/or 830 and/or servers 840 and/or 845 may include all or a portion of system 400 from FIG. 4.

As illustrated in FIG. 8, one or more storage devices 860(1)-(N) may be directly attached to server 840. Similarly, one or more storage devices 870(1)-(N) may be directly attached to server 845. Storage devices 860(1)-(N) and storage devices 870(1)-(N) generally represent any type or form of storage device or medium capable of storing data and/or other computer-readable instructions. In certain embodiments, storage devices 860(1)-(N) and storage devices 870(1)-(N) may represent Network-Attached Storage (NAS) devices configured to communicate with servers 840 and 845 using various protocols, such as Network File System (NFS), Server Message Block (SMB), or Common Internet File System (CIFS).

Servers 840 and 845 may also be connected to a Storage Area Network (SAN) fabric 880. SAN fabric 880 generally represents any type or form of computer network or architecture capable of facilitating communication between a plurality of storage devices. SAN fabric 880 may facilitate communication between servers 840 and 845 and a plurality of storage devices 890(1)-(N) and/or an intelligent storage array 895. SAN fabric 880 may also facilitate, via network 850 and servers 840 and 845, communication between client systems 810, 820, and 830 and storage devices 890(1)-(N) and/or intelligent storage array 895 in such a manner that devices 890(1)-(N) and array 895 appear as locally attached devices to client systems 810, 820, and 830. As with storage devices 860(1)-(N) and storage devices 870(1)-(N), storage devices 890(1)-(N) and intelligent storage array 895 generally represent any type or form of storage device or medium capable of storing data and/or other computer-readable instructions.

In certain embodiments, and with reference to example computing system 710 of FIG. 7, a communication interface, such as communication interface 722 in FIG. 7, may be used to provide connectivity between each client system 810, 820, and 830 and network 850. Client systems 810, 820, and 830 may be able to access information on server 840 or 845 using, for example, a web browser or other client software. Such software may allow client systems 810, 820, and 830 to access data hosted by server 840, server 845, storage devices 860(1)-(N), storage devices 870(1)-(N), storage devices 890(1)-(N), or intelligent storage array 895. Although FIG. 8 depicts the use of a network (such as the Internet) for exchanging data, the embodiments described and/or illustrated herein are not limited to the Internet or any particular network-based environment.

In at least one embodiment, all or a portion of one or more of the example embodiments disclosed herein may be encoded as a computer program and loaded onto and executed by server 840, server 845, storage devices 860(1)-(N), storage devices 870(1)-(N), storage devices 890(1)-(N), intelligent storage array 895, or any combination thereof. All or a portion of one or more of the example embodiments disclosed herein may also be encoded as a computer program, stored in server 840, run by server 845, and distributed to client systems 810, 820, and 830 over network 850.

As detailed above, computing system 710 and/or one or more components of network architecture 800 may perform and/or be a means for performing, either alone or in combination with other elements, one or more steps of an example method for real-time AI-driven image analysis with multi-model architecture.

### EXAMPLES

Example 1. A system comprising: an image accessing module configured to access one or more images; a model identifying module configured to identify which one or more of a plurality of available image analysis models are to be implemented to perform one or more image analysis tasks related to the accessed images; an instantiation module configured to instantiate the one or more identified image analysis models to perform the one or more image analysis tasks related to the accessed images; and an image data generating module configured to generate image metadata associated with the one or more images, wherein each of the identified image analysis models provides different metadata information related to the accessed images.

Example 2: The system of Example 1, further comprising an image categorizing module configured to categorize the one or more images based on the different metadata information provided by the identified image analysis models.

Example 3: The system of any of Examples 1-2, wherein the different metadata generated by the identified image analysis models comprises image tags.

Example 4: The system of any of Examples 1-3, wherein the image tags generated by the identified image analysis models are searchable according to at least one of keywords or phrases.

Example 5: The system of any of Examples 1-4, wherein the at least one image analysis tasks related to the accessed images comprises identifying a specific object or person.

Example 6: The system of any of Examples 1-5, wherein multiple different image analysis models are used to identify different features of the same object or person.

Example 7: The system of any of Examples 1-6, wherein the at least one image analysis tasks related to the accessed images comprises identifying a specific object or person at a specified event.

Example 8: The system of Example 7, wherein multiple different image analysis models are used to identify different features of the same object or person at the specified event.

Example 9: The system of any of Examples 7-8, wherein at least one of the available image analysis models is deactivated and is not used for analyzing images associated with the specified event.

Example 10: The system of any of Examples 1-9, wherein the image analysis models comprise at least one of artificial intelligence (AI) models or machine learning (ML) models.

Example 11: The system of any of Examples 1-10, wherein the AI or ML models comprise at least one of: an object detection model, an alphanumeric recognition model, a facial recognition model, a color recognition model, a graphic or logo detection model, an anomaly detection model, or a content masking model.

Example 12: The system of any of Examples 1-11, further comprising a camera interface that directly captures and transfers image data to a specified data store for access by the image accessing module.

Example 13: A computer-implemented method comprising: accessing one or more images; identifying which one or more of a plurality of available image analysis models are to be implemented to perform one or more image analysis tasks related to the accessed images; instantiating the one or more identified image analysis models to perform the one or more image analysis tasks related to the accessed images; and generating image metadata associated with the one or more images, wherein each of the identified image analysis models provides different metadata information related to the accessed images.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 400 in FIG. 4 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In various embodiments, all or a portion of example system 400 in FIG. 4 may facilitate multi-tenancy within a cloud-based computing environment. In other words, the software modules described herein may configure a computing system (e.g., a server) to facilitate multi-tenancy for one or more of the functions described herein. For example, one or more of the software modules described herein may program a server to enable two or more clients (e.g., customers) to share an application that is running on the server. A server programmed in this manner may share an application, operating system, processing system, and/or storage system among multiple customers (i.e., tenants). One or more of the modules described herein may also partition data and/or configuration information of a multi-tenant application for each customer such that one customer cannot access data and/or configuration information of another customer.

According to various embodiments, all or a portion of example system 400 in FIG. 4 may be implemented within a virtual environment. For example, the modules and/or data described herein may reside and/or execute within a virtual machine. As used herein, the term “virtual machine” generally refers to any operating system environment that is abstracted from computing hardware by a virtual machine manager (e.g., a hypervisor). Additionally or alternatively, the modules and/or data described herein may reside and/or execute within a virtualization layer. As used herein, the term “virtualization layer” generally refers to any data layer and/or application layer that overlays and/or is abstracted from an operating system environment. A virtualization layer may be managed by a software virtualization solution (e.g., a file system filter) that presents the virtualization layer as though it were part of an underlying base operating system. For example, a software virtualization solution may redirect calls that are initially directed to locations within a base file system and/or registry to locations within a virtualization layer.

In some examples, all or a portion of example system 400 in FIG. 4 may represent portions of a mobile computing environment. Mobile computing environments may be implemented by a wide range of mobile computing devices, including mobile phones, tablet computers, e-book readers, personal digital assistants, wearable computing devices (e.g., computing devices with a head-mounted display, smartwatches, etc.), and the like. In some examples, mobile computing environments may have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein may be provided for a mobile computing environment and/or may interact with a mobile computing environment.

In addition, all or a portion of example system 400 in FIG. 4 may represent portions of, interact with, consume data produced by, and/or produce data consumed by one or more systems for information management. As used herein, the term “information management” may refer to the protection, organization, and/or storage of data. Examples of systems for information management may include, without limitation, storage systems, backup systems, archival systems, replication systems, high availability systems, data search systems, virtualization systems, and the like.

In some embodiments, all or a portion of example system 400 in FIG. 4 may represent portions of, produce data protected by, and/or communicate with one or more systems for information security. As used herein, the term “information security” may refer to the control of access to protected data. Examples of systems for information security may include, without limitation, systems providing managed security services, data loss prevention systems, identity authentication systems, access control systems, encryption systems, policy compliance systems, intrusion detection and prevention systems, electronic discovery systems, and the like.

According to some examples, all or a portion of example system 400 in FIG. 4 may represent portions of, communicate with, and/or receive protection from one or more systems for endpoint security. As used herein, the term “endpoint security” may refer to the protection of endpoint systems from unauthorized and/or illegitimate use, access, and/or control. Examples of systems for endpoint protection may include, without limitation, anti-malware systems, user authentication systems, encryption systems, privacy systems, spam-filtering services, and the like.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

In addition, one or more of the modules described herein may transform data, physical devices, and/or representations of physical devices from one form to another. For example, one or more of the modules recited herein may receive image data to be transformed, transform the image data, output a result of the transformation to classify the image data, use the result of the transformation to create corresponding metadata, and store the result of the transformation to persist metadata with the image data. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for real-time AI-driven image analysis with multi-model architecture, at least a portion of the method being performed by a computing device comprising at least one processor, the method comprising:
receiving image data having a corresponding processing configuration;
identifying a processing status for the received image data, the processing status indicating prior image analysis on the image data;
determining, from the processing status and the processing configuration, one or more image analysis operations to be performed to create metadata for the image data;
coordinating one or more artificial intelligence (AI) models to perform the one or more image analysis operations and create the metadata; and
outputting the metadata for the image data.

2. The computer-implemented method of claim 1, further comprising updating the processing status after completing an image analysis operation to indicate completion of the image analysis operation and storage of a corresponding analysis result.

3. The computer-implemented method of claim 1, wherein the metadata comprises at least one of: object metadata identifying an object represented in the image data, facial metadata identifying a person represented in the image data, alphanumeric metadata extracted from text represented in the image data, color metadata identifying at least one color represented in the image data, graphic metadata identifying a graphic represented in the image data, logo metadata identifying a logo represented in the image data, or credential metadata identifying credential information represented in the image data.

4. The computer-implemented method of claim 1, further comprising modifying the image data based on the metadata and the processing configuration.

5. The computer-implemented method of claim 4, wherein modifying the image data further comprises at least one of: obscuring sensitive information in the image data, embedding the metadata into the image data, or updating embedded metadata in the image data.

6. The computer-implemented method of claim 1, wherein coordinating the one or more AI models comprises, for an image analysis operation of the one or more image analysis operations, using a stored prior analysis result identified from the processing status when the stored prior analysis result is available for the image data and otherwise causing execution of an AI model corresponding to the image analysis operation.

7. The computer-implemented method of claim 6, wherein the stored prior analysis result comprises a cached detection result generated during prior processing of the image data for the image analysis operation.

8. The computer-implemented method of claim 7, wherein, when the processing configuration has changed, the method comprises reapplying event-specific filtering or output logic to the cached detection result without rerunning the AI model corresponding to the image analysis operation.

9. A system for real-time AI-driven image analysis with multi-model architecture, the system comprising:
one or more processing nodes configured to host at least one artificial intelligence (AI) model trained for image analysis;
at least one physical processor;
physical memory comprising computer-executable instructions that, when executed by the physical processor, cause the physical processor to:
receive image data having a corresponding processing configuration;
identify a processing status associated with the image data, the processing status indicating prior image analysis on the image data;
determine, from the processing status and the processing configuration, one or more image analysis operations to be performed to create metadata for the image data;
coordinate the one or more processing nodes to perform the one or more image analysis operations using the at least one AI model to create the metadata; and
output the metadata.

10. The system of claim 9, wherein coordinating the one or more processing nodes comprises selecting a processing node that hosts an AI model corresponding to the one or more image analysis operations to execute the AI model.

11. The system of claim 9, wherein coordinating the one or more processing nodes comprises distributing non-overlapping image analysis operations to different processing nodes based on analysis type.

12. The system of claim 9, wherein coordinating the one or more processing nodes comprises using, for the one or more image analysis operations, a stored prior analysis result identified from the processing status.

13. The system of claim 9, wherein coordinating the one or more processing nodes comprises selectively activating an AI model hosted by a processing node based on availability of at least one of processing capacity, memory capacity, or graphics processing capacity of the processing node.

14. The system of claim 9, wherein each processing node stores a local cache comprising prior analysis results and processing status for AI models hosted by the processing node.

15. The system of claim 9, wherein outputting the metadata comprises writing tags to EXIF metadata of the image data.

16. The system of claim 9, wherein outputting the metadata comprises classifying the image data within a searchable image catalog.

17. The system of claim 9, wherein the metadata comprises at least one of: object metadata, facial metadata, alphanumeric metadata, color metadata, graphic metadata, logo metadata, or credential metadata.

18. The system of claim 9, wherein the computer-executable instructions, when executed by the at least one physical processor, further cause the at least one physical processor to redact a portion of the image data based on the metadata indicating sensitive information.

19. The system of claim 9, wherein coordinating the one or more processing nodes comprises, for an image analysis operation of the one or more image analysis operations, using a stored prior analysis result identified from the processing status when the stored prior analysis result is available for the image data and otherwise causing execution of an AI model corresponding to the image analysis operation.

20. A non-transitory computer-readable medium comprising one or more computer-executable instructions that, when executed by at least one processor of a computing device, cause the computing device to:
receive image data having a corresponding processing configuration;
identify a processing status for the received image data, the processing status indicating prior image analysis on the image data;
determine, from the processing status and the processing configuration, one or more image analysis operations to be performed to create metadata for the image data;
coordinate one or more artificial intelligence (AI) models to perform the one or more image analysis operations and create the metadata; and
output the metadata for the image data.
